(19) United States
(12) Patent Application Publication
(10) Pub. No.: US 2016/0339455 A1
(43) Pub. Date: Nov. 24, 2016

(54) SIDE-KNOB TYPE MULTI-FUNCTION SHOWER ARM AND METHOD OF IMPLEMENTING THE SAME

(71) Applicant: Xiamen Runner Industrial Corporation, Xiamen (CN)

(72) Inventors: Wen-kun Lin, Xiamen (CN); Yuan-shan Liang, Xiamen (CN); Sheng-chao Dai, Xiamen (CN)

(21) Appl. No.: 15/135,134

(22) Filed: Apr. 21, 2016

(30) Foreign Application Priority Data
May 18, 2015 (CN) 201510249979.0

(51) Int. Cl. B05B 1/16; E03C 1/04; B05B 1/18; E03C 1/02

(52) U.S. Cl. CPC B05B 1/1681; E03C 1/023; E03C 1/0409; B05B 1/18

(57) ABSTRACT

A side-knob type multi-function shower arm and a method of implementing the same. The method comprises two water output modes: (1) a shower head water output mode: when handle of a function switching knob is rotated to point vertically downward, a three-way splitter is brought to connect the water input channel of main body to a shower head water output channel, so that water flows to the shower head water output channel, and then flows directly out from a shower head; and (2) a shower water output mode: when the handle of the function switching knob is then rotated 90 degrees counterclockwise, the three-way splitter is brought to connect the water input channel of the main body to a shower water output channel, so that water flows to the shower water output channel, and then flows out a shower from an outside connected shower hose.

### BACKGROUND OF THE INVENTION

1. Field of the Invention

The present invention relates to a shower arm, and in particular to a side-knob type multi-function shower arm and method of implementing the same, used in bathing and sanitary equipment.

2. The Prior Arts

Conventionally, the structure of a shower arm is simple and easy, and it is provided only with a water input interface and a shower head interface. In application, it requires an additional and independent three-way splitter to perform switching between the shower head water output and the shower arm water output. Since the shower arm and the three-way splitter are separate pieces, user has to purchase and install them separately. As such, it has the problem of difficulties in compatibility, installation, and application.

Therefore, presently, the design and performance of the shower arm is not quite satisfactory, and it leaves much room for improvement.

### SUMMARY OF THE INVENTION

In view of the problems and drawbacks of the prior art, the present invention provides a side-knob type multi-function shower arm and method of implementing the same, to overcome the shortcomings of the prior art.

In order to achieve the objective mentioned above, the present invention provides a side-knob type multi-function shower arm, including: a main body, a three-way splitter, and a function switching knob. Wherein, the main body includes a water input interface, a shower head interface, and a shower interface. The water input interface is disposed at a rear end of the main body; the shower head interface is disposed at a front end of the main body, and is used for installing a shower head; and the shower interface is disposed at a bottom of the main body, and is used for connecting to a shower hose. The three-way splitter is disposed in the main body, for controlling flow of water to the shower head or a shower. The function switching knob is disposed at a side of the main body, and is used to operate the three-way splitter.

In an aspect of the present invention, a spacer, a ratchet washer, and a check valve having water saving plate are disposed at a rear end of the main body, along a direction of water input.

In another aspect of the present invention, a front end of the main body is inclined downward, and a joint is installed in the shower head interface through its inner threads for connecting to the shower head, while center of the joint is provided with a ring shape indent slot, in which is received and sleeved an O-shape seal ring, in tight seal contact with an inner wall of the shower head interface.

In a further aspect of the present invention, the three-way splitter includes a core axis installed laterally at a T-joint in the main body. Along an operation end of the core axis is provided with a ring shape fastening slot. The operation end of the core axis passing through a through hole in center of a side wall of the main body, for fastening the ring shape fastening slot through using a C shape fastening ring. The function switching knob is fixedly connected to the operation end of the core axis through a tight lock screw, while an arc shape slot is provided on a side wall of the main body. And beads are provided in function switching knob, to act in sliding cooperation with the arc shape slot through a positioning spring.

In yet another aspect of the present invention, a ring shape indent slots is each provided on both ends of the core axis. The O-shape seal ring is sleeved around the ring shape indent slot in tight seal contact with a side wall of the main body. In a middle portion and on a side of the core axis is provided with a positioning slot, while in the positioning slot is provided with a tight seal plug for selectively sealing a shower head water output channel or a shower water output channel through using a tight seal spring. In the middle portion and on the other side of the core axis is provided with a water output slot, connecting to the shower head water output channel or the shower water output channel. A bottom portion of the water output slot is connected to a bottom portion of the positioning slot through a small hole.

In an aspect of the present invention, a plurality of ribs are disposed at the bottom portion of the water output slot, to slow down the speed of water flow.

In another aspect of the present invention, an end cap covering a tight lock screw is fastened onto the function switching knob, while another end cap is fastened around an opening on another side wall of the main body.

The present invention also provides a side-knob type multi-function shower arm water output method, comprising following two water output modes:

(1) a shower head water output mode: when the handle of the function switching knob is rotated to point vertically downward, a three-way splitter is brought to connect a water input channel of a main body to a shower head water output channel, so that water flows to the shower head water output channel, and then flows directly out from a shower head; and

(2) a shower water output mode: when the handle of the function switching knob is then rotated 90 degrees counterclockwise, the three-way splitter is brought to connect the water input channel of the main body to a shower water output channel, so that water flows to the shower water output channel, and then flows out a shower from an outside connected shower hose.

Compared with the Prior Art, the present invention has the advantages that, it combines the conventional shower arm and the three-way splitter together into one piece, while keeping their functions. Also, it solves the problem of the user having to purchase and install the two pieces separately. Therefore, it is novel in design, easy to install, convenient to use, and having a compact and handsome appearance.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a side-knob type multi-function shower arm according to an embodiment of the present invention;

FIG. 2 is an exploded view of a side-knob type multi-function shower arm according to an embodiment of the present invention;

FIG. 3 is a schematic diagram showing handle position of a function switching knob when water is output from a shower head according to an embodiment of the present invention;

FIG. 4 is a cross section view of a shower head when it outputs water according to an embodiment of the present invention;

FIG. 5 is a schematic diagram showing handle position of a function switching knob when water is output from a shower according to an embodiment of the present invention;

FIG. 6 is a cross section view of a shower when it outputs water according to an embodiment of the present invention;

FIG. 7 is an enlarged view of a core axis according to an embodiment of the present invention; and

FIG. 8 is a cross section view of a core axis according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

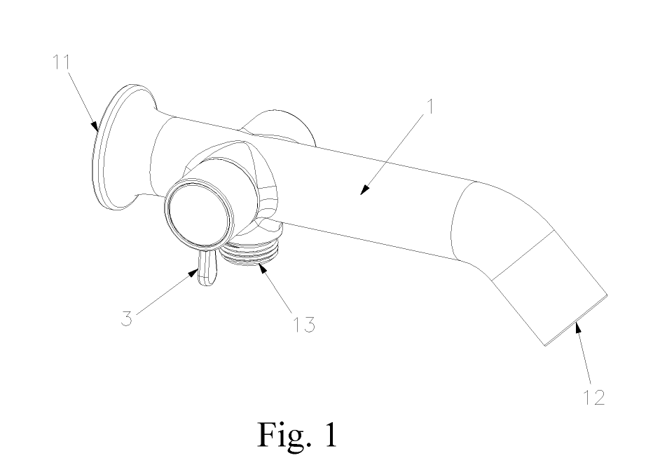

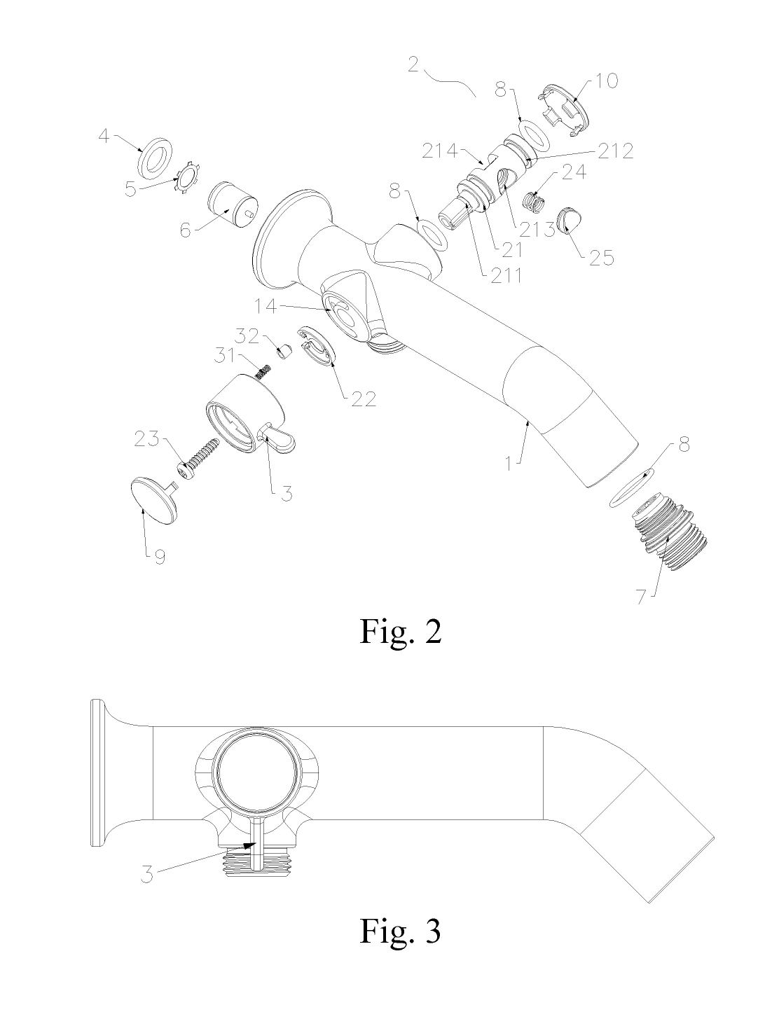

Refer to FIGS. 1 to 8 respectively for a schematic diagram of a side-knob type multi-function shower arm according to an embodiment of the present invention; an exploded view of a side-knob type multi-function shower arm according to an embodiment of the present invention; a schematic diagram showing handle position of a function switching knob when water is output from a shower head according to an embodiment of the present invention; a cross section view of a shower head when it outputs water according to an embodiment of the present invention; a schematic diagram showing handle position of a function switching knob when water is output from a shower according to an embodiment of the present invention; a cross section view of a shower when it outputs water according to an embodiment of the present invention; an enlarged view of a core axis according to an embodiment of the present invention; and a cross section view of a core axis according to an embodiment of the present invention.

As shown in FIGS. 1 to 8, the present invention provides a side-knob type multi-function shower arm, including: a main body 1, a three-way splitter 2, and a function switching knob 3. Wherein, the main body 1 includes a water input interface 11, a shower head interface 12, and a shower interface 13. The water input interface 11 is disposed at a rear end of the main body 1; the shower head interface 12 is disposed at a front end of the main body 1, and is used for installing a shower head; and the shower interface 13 is disposed at a bottom of the main body 1, and is used for connecting to a shower hose. The three-way splitter 2 is disposed in the main body 1, for controlling flow of water to the shower head or a shower. The function switching knob 3 is disposed at a side of the main body 1, and is used to operate the three-way splitter 2.

In an embodiment of the present invention, a spacer 4, a ratchet washer 5, and a check valve 6 having water saving plate are disposed at a rear end of the main body 1, along a direction of water input. The water input interface 11 is provided with inner threads, while the spacer 4 is disposed at bottom portion of the water input interface 11, to ensure water leakage will not occur when water is input. The ratchet washer 5 is used to press tightly the check valve 6 having water saving plate, to prevent loosening of the check valve 6, and to ensure that water will from the water input channel of the main body 1 to either the shower head water output channel or the shower water output channel.

In an embodiment of the present invention, a front end of the main body 1 is inclined downward to facilitate showering. A joint 7 is installed in the shower head interface 12 through its inner threads for connecting to the shower head, while center of the joint 7 is provided with a ring shape indent slot, in which is received with an 0-shape seal ring 8, in tight seal contact with an inner wall of the shower head interface 12. The shower head can be connected directly and easily through using the outer threads at the front end of the joint 7. As such, it is convenient to install and detach.

In an embodiment of the present invention, the three-way splitter 2 includes a core axis 21 installed laterally at a T-joint in the main body 1. Along an operation end of the core axis 21 is provided with a ring shape fastening slot 211. The operation end of the core axis 21 passing through a through hole in center of a side wall of the main body 1, for fastening the ring shape fastening slot 211 through using a C shape fastening ring 22. The function switching knob 3 is fixedly connected to the operation end of the core axis 21 through a tight lock screw 23, while an arc shape slot 14 is provided on a side wall of the main body 1. And beads 32 are provided in function switching knob 3, to act in sliding cooperation with the arc shape slot 14 through a positioning spring 31.

In an embodiment of the present invention, a ring shape indent slots 212 is each provided on both ends of the core axis 21. The 0-shape seal ring 8 is sleeved around the ring shape indent slot 212 in tight seal contact with a side wall of the main body 1. In a middle portion and on a side of the core axis 21 is provided with a positioning slot 213, in the positioning slot 213 is provided with a tight seal plug 25 (cat eye pad) for selectively sealing a shower head water output channel or a shower water output channel through using a tight seal spring 24. In the middle portion and on the other side of the core axis 21 is provided with a water output slot 214, connecting to the shower head water output channel or the shower water output channel.

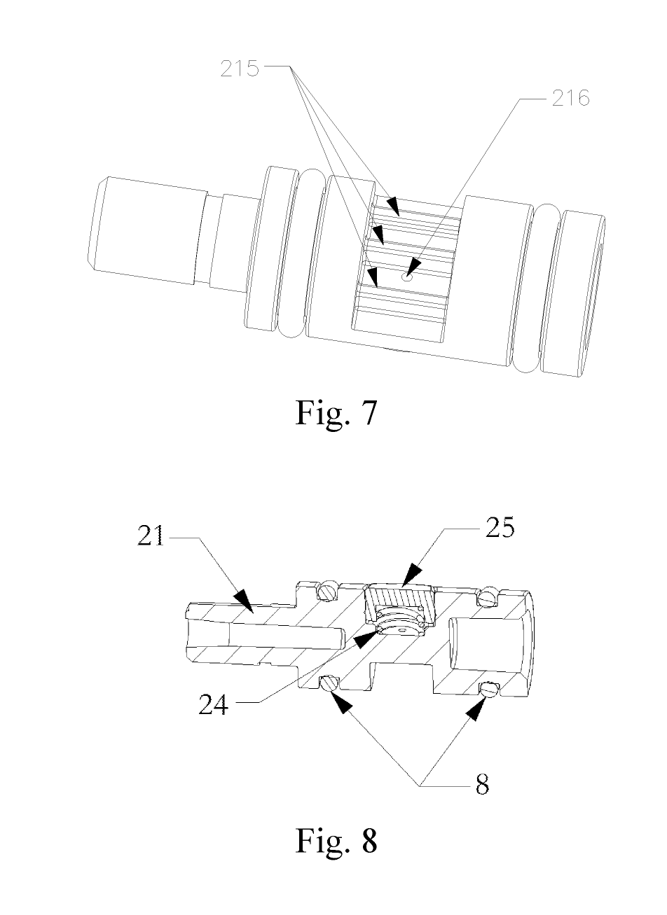

In an embodiment of the present invention, as shown in FIGS. 7 and 8, a bottom portion of the water output slot 214 is connected to a bottom portion of the positioning slot 213 through a small hole 216. Water flows through the small hole 216 to press tightly against the tight seal plug 25, to ensure better tight seal effect. Three ribs 215 are disposed at the bottom portion of the water output slot 214, to slow down the speed of water flow.

In an embodiment of the present invention, a left end cap 9 covering a tight lock screw 23 is fastened onto the function switching knob 3, while a right end cap 10 is fastened around an opening on the right side wall of the main body 1, so that three-way splitter 2 is placed securely in the main body 1, to ensure an overall compact appearance, and prevent contamination of the accessories contained therein.

The present invention also provides a side-knob type multi-function shower arm water output method, comprising following two water output modes:

(1) a shower head water output mode: when the handle of the function switching knob 3 is rotated to point vertically downward, a three-way splitter 2 is brought to connect the water input channel of a main body 1 to a shower head water output channel, so that water flows to the shower head water output channel, and then flows directly out from a shower head; and

(2) a shower water output mode: when the handle of the function switching knob 3 is then rotated 90 degrees counterclockwise, the three-way splitter 2 is brought to connect the water input channel of the main body 1 to a shower water output channel, so that water flows to the shower water output channel, and then flows out a shower from an outside connected shower hose.

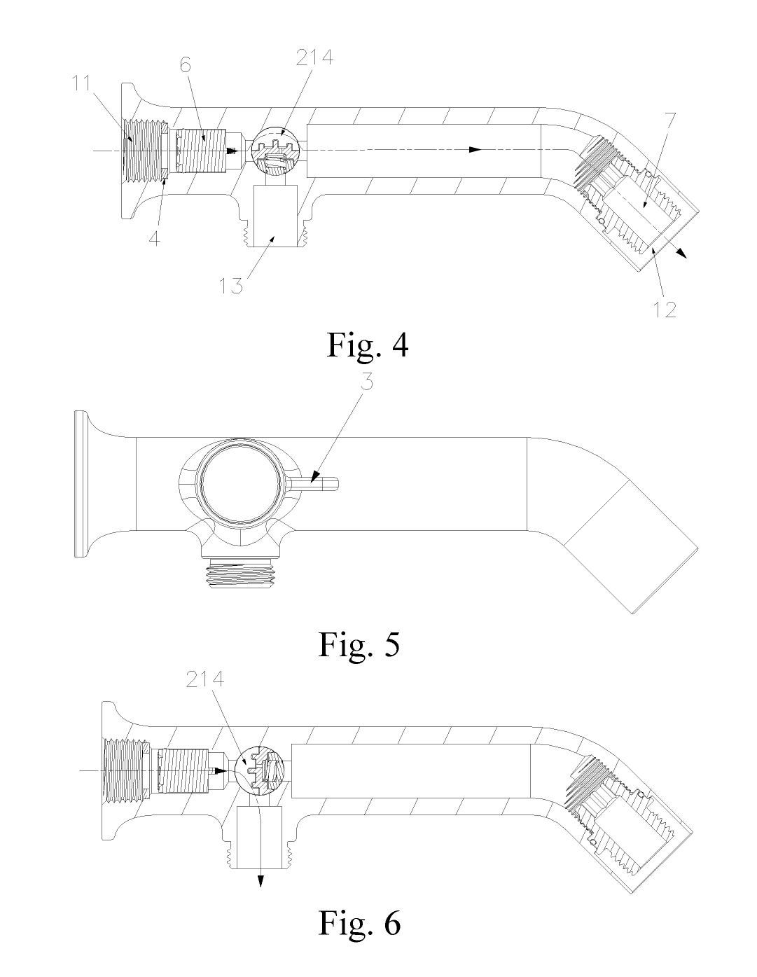

In an embodiment of the present invention, as shown in FIGS. 3 and 4, when selecting the shower head water output mode, at this time, the handle of the function switching knob 3 is rotated to point vertically downward, so that the tight seal plug 25 on the core axis 21 blocks the shower water output channel, to cause the connection of the water output slot 214 and the shower head water output channel.

In an embodiment of the present invention, alternatively, as shown in FIGS. 5 and 6, when selecting the shower water output mode, at this time, the handle of the function switching knob 3 is rotated 90 degrees counterclockwise, so that the tight seal plug 25 on the core axis 21 blocks the shower head water output channel, to cause the connection of the water output slot 214 and the shower water output channel.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A side-knob type multi-function shower arm, comprising:
a main body, including:
a water input interface, disposed at a rear end of the main body;
a shower head interface, disposed at a front end of the main body, and is used for installing a shower head;
a shower interface, disposed at a bottom of the main body, and is used for connecting to a shower hose;
a three-way splitter, disposed in the main body, for controlling flow pf water to the shower head or a shower; and
a function switching knob, disposed at a side of the main body, used to operate the three-way splitter.

2. The side-knob type multi-function shower arm as claimed in claim 1, wherein a spacer, a ratchet washer, and a check valve having water saving plate are disposed at a rear end of the main body, along a direction of water input.

3. The side-knob type multi-function shower arm as claimed in claim 1, wherein a front end of the main body is inclined downward, and a joint is installed in the shower head interface through its inner threads for connecting to the shower head, while center of the joint is provided with a ring shape indent slot, in which is received and sleeved an 0-shape seal ring, in tight seal contact with an inner wall of the shower head interface.

4. The side-knob type multi-function shower arm as claimed in claim 1, wherein the three-way splitter includes a core axis installed laterally at a T-joint in the main body, along an operation end of the core axis is provided with a ring shape fastening slot, the operation end of the core axis passing through a through hole in center of a side wall of the main body, for fastening the ring shape fastening slot through using a C shape fastening ring, the function switching knob is fixedly connected to the operation end of the core axis through a tight lock screw, an arc shape slot is provided on a side wall of the main body, and beads are provided in function switching knob, to act in sliding cooperation with the arc shape slot through a positioning spring.

5. The side-knob type multi-function shower arm as claimed in claim 4, wherein a ring shape indent slots is each provided on both ends of the core axis, the 0-shape seal ring is sleeved around the ring shape indent slot in tight seal contact with a side wall of the main body, in a middle portion and on a side of the core axis is provided with a positioning slot, in the positioning slot is provided with a tight seal plug for selectively sealing a shower head water output channel or a shower water output channel through using a tight seal spring, in the middle portion and on the other side of the core axis is provided with a water output slot, connecting to the shower head water output channel or the shower water output channel, a bottom portion of the water output slot is connected to a bottom portion of the positioning slot through a small hole.

6. The side-knob type multi-function shower arm as claimed in claim 5, wherein a plurality of ribs are disposed at the bottom portion of the water output slot, to slow down the speed of water flow.

7. The side-knob type multi-function shower arm as claimed in claims 4, wherein an end cap covering a tight lock screw is fastened onto the function switching knob, while another end cap is fastened around an opening on another side wall of the main body.

8. The side-knob type multi-function shower arm as claimed in claims 5, wherein an end cap covering a tight lock screw is fastened onto the function switching knob, while another end cap is fastened around an opening on another side wall of the main body.

9. A water output method used to perform a side-knob type multi-function shower arm as claimed in claim 1, comprising following two water output modes:
(1) a shower head water output mode: when a handle of a function switching knob is rotated to point vertically downward, a three-way splitter is brought to connect the water input channel of a main body to a shower head water output channel, so that water flows to the shower head water output channel, and then flows directly out from a shower head; and
(2) a shower water output mode: when the handle of the function switching knob, is then rotated 90 degrees counterclockwise, the three-way splitter is brought to connect the water input channel of the main body to a shower water output channel, so that water flows to the shower water output channel, and then flows out a shower from an outside connected shower hose.
